(19) United States
(12) Patent Application Publication
(10) Pub. No.: US 2025/0386313 A1
(43) Pub. Date: Dec. 18, 2025

(54) METHODS AND APPARATUS FOR ENABLING STATELESS COMMUNICATION IN A MOBILE NETWORK

(71) Applicant: InterDigital Patent Holdings, Inc., Wilmington, DE (US)

(72) Inventors: Mohamad Kenan Al-Hares, Canterbury (GB); Michel Roy, Candiac, CA (US); Ulises Olvera-Hernandez, Saint-Lazare, CA (US); Zhibi Wang, Woodridge, IL (US); Michael Starsinic, Newtown, PA (US); Taimoor Abbas, Sainte-Julie, CA (US)

(73) Assignee: InterDigital Patent Holdings, Inc., Wilmington, DE (US)

(21) Appl. No.: 18/743,384

(22) Filed: Jun. 14, 2024

(51) Int. Cl. H04W 60/00

(52) U.S. Cl. CPC H04W 60/00

(57) ABSTRACT

A wireless transmit/receive unit (WTRU) transmits, to an Access and Mobility Management Function (AMF) in a network, a registration request including information indicating that a communication with the network is requested. In an example, the communication may be stateless communication (SC). The WTRU receives, from the AMF, a registration accept message including a communication token (CT). In an example, the CT may be granted by a communication management function (CMF). Additionally or alternatively, the CMF may be a stateless CMF (SCMF). Additionally or alternatively, the CT may be a stateless CT (SCT). Further, the WTRU determines to transmit data to the network. The WTRU determines that a connection between the WTRU and the network is unstable. The WTRU transmits a communication request message to the network, including the CT. The WTRU receives a communication response from the network. Additionally or alternatively, the communication response includes a confirmation of data transmission.

### BACKGROUND

In 3^{rd} Generation Partnership Project (3GPP) communication, a wireless transmit/receive unit (WTRU) will register with an access network. For example, the WTRU may send a registration request to an access node (AN). The AN may be part of a base station or an access point, or may be located in a core network (CN) and may be in communication with the base station or access point.

In turn, the AN may communicate with an Access and Mobility Management Function (AMF). The AMF may be located in the CN. The AN and AMF may exchange messages as part of a registration procedure.

### SUMMARY

A wireless transmit/receive unit (WTRU) transmits, to an Access and Mobility Management Function (AMF) in a network, a registration request including information indicating that a communication with the network is requested. In an example, the communication may be stateless communication (SC).

Additionally or alternatively, the registration request may include information about requested communication operations. Additionally or alternatively, the information about requested communication operations may include one or more of an operation type, network function identities, application function identities, payload size, payload type, endpoint information, and the like.

The WTRU receives, from the AMF, a registration accept message including a communication token (CT). In an example, the CT may be granted by a communication management function (CMF). Additionally or alternatively, the CMF may be a stateless communication management function (SCMF). Additionally or alternatively, the CT may be a stateless CT (SCT).

Further, the WTRU determines to transmit data to the network. Also, the WTRU determines that a connection between the WTRU and the network is unstable. The determination the connection is unstable may be based on the WTRU connection becoming idle, or the WTRU becoming de-registered. Additionally or alternatively, the WTRU may detect connection instability, for example detecting an increase in bit error rate (BER), detecting a low receive power, losing radio coverage, or detecting a low battery which may limit transmission power or range.

Also, the WTRU transmits a communication request message to the network, including the CT. Additionally or alternatively, the communication request message may be one or more of a non-access stratum (NAS) message, a message transparent or opaque to the Access Network, a message intended to be further processed by the Access Network, or any other message type. Additionally or alternatively, the communication request message may be sent directly from the WTRU to a network function (NF) in the network using a Service Based like mechanism, such as, over quick user datagram protocol (UDP) internet connections (QUIC).

Moreover, the WTRU receives a communication response from the network. Additionally or alternatively, the communication response includes a confirmation of data transmission. Additionally or alternatively, the communication response is received from the CMF.

Additionally or alternatively, the communication response includes indication information indicating that one or more CT rules have changed. Additionally or alternatively, the communication response is an SC response.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signaling diagram illustrating an example of a registration procedure;

FIG. 3 is a signaling diagram illustrating an example of a procedure for requesting access to a communication capability and obtaining a communication token (CT);

FIG. 4 is a signaling diagram illustrating an example of a procedure for WTRU communication using a CT;

FIG. 5 is a flowchart diagram illustrating an example of requesting access to a communication capability and obtaining a CT;

FIG. 6 is a signaling diagram illustrating an example of a procedure for updating a CT; and

FIG. 7 is a signaling diagram illustrating an example of a procedure for CT usage with non-3^{rd} Generation Partnership Project (3GPP) networks.

### DETAILED DESCRIPTION

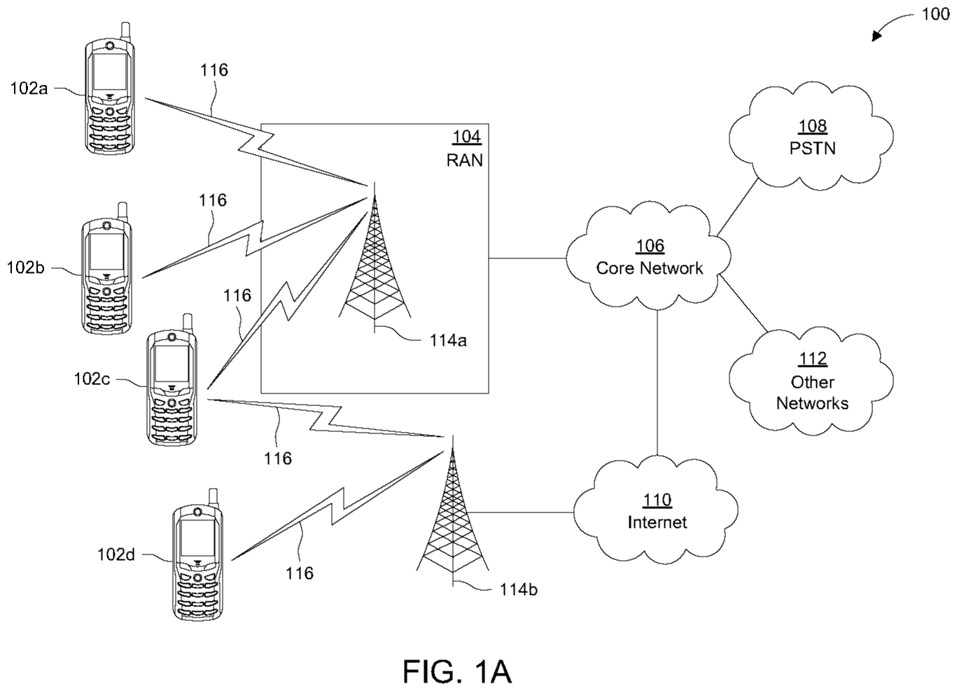

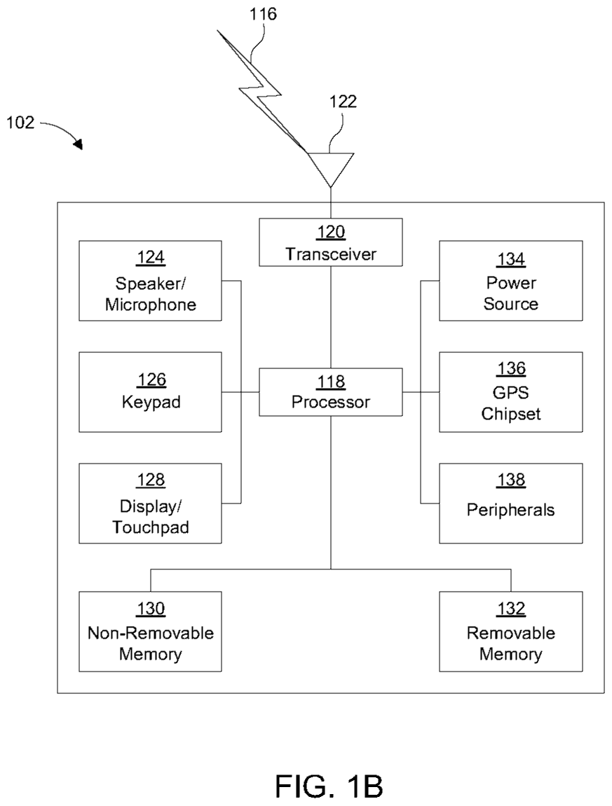

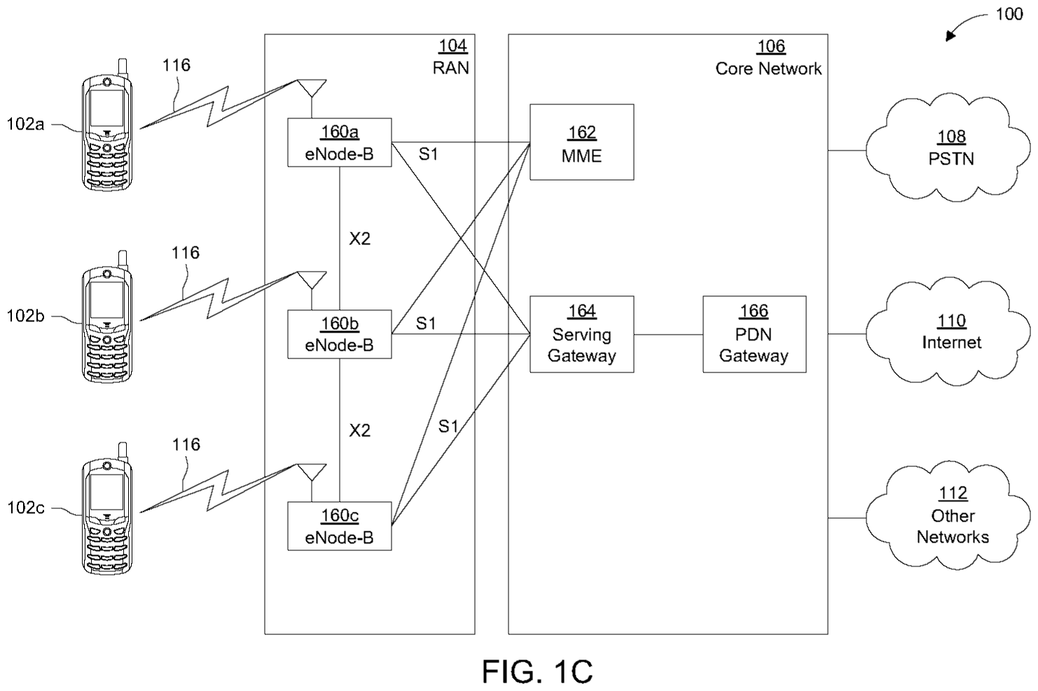

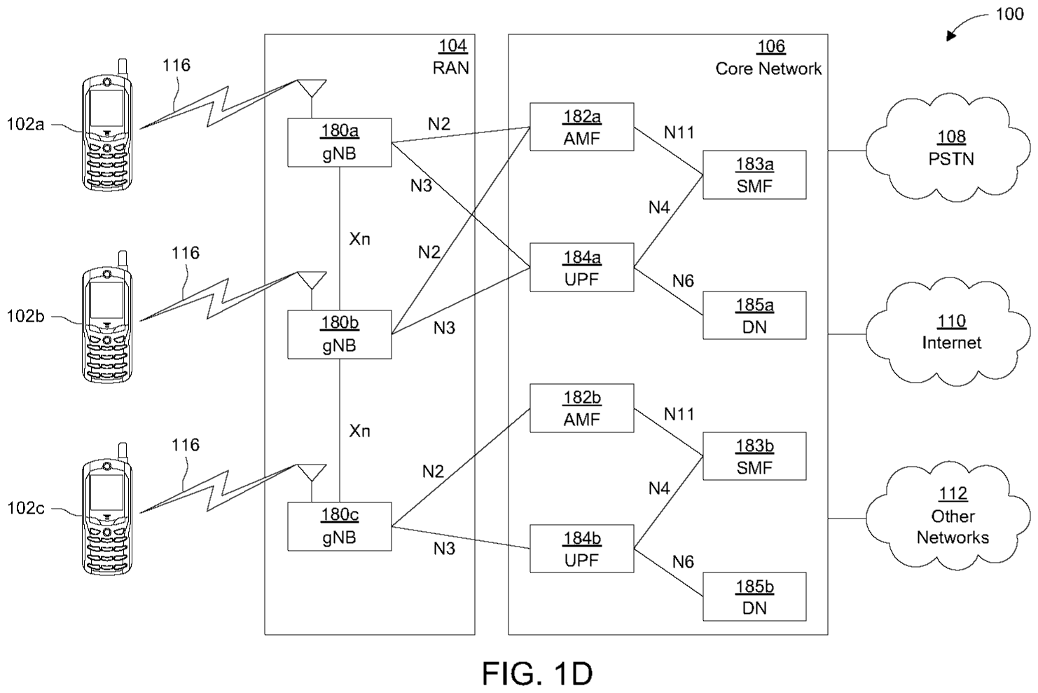

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3^{rd} Generation Partnership Project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A Communication Management Function (CMF) and a Stateless Communication Management Function (SCMF) are functionalities developed herein considering a Fifth Generation (5G) CN (5GC). Further, the functionalities provided extend beyond 5G wireless systems. For example, the sixth generation (6G) of wireless systems may use one or more functionalities, embodiments or examples provided herein. The CMF or SCMF may be embodied as a standalone new network function or as part of the functional logic of an existing Network Function (NF).

A communication service provider and communication authorization server can be in the same entity or can be in separate entities in the network. Similarly, a Stateless Communication (SC) service provider and SC authorization server can be in the same entity or can be in separate entities in the network. In examples and embodiments provided herein, the communication service provider and communication authorization server are located at the same entity, the CMF. Likewise, in examples and embodiments provided herein, the SC service provider and SC authorization server are located at the same entity, the SCMF.

In embodiments and examples provided herein, the terms Communication Token (CT), Stateless Communication Token (SCT) and token may be used interchangeably. Also, the terms data and information are used interchangeably in embodiments and examples provided herein. Further, the terms high priority, important and urgent are used interchangeably in embodiments and examples provided herein.

Embodiments and examples provided herein describe actions that can be taken by a WTRU. The actions that are described as being performed by the WTRU may alternatively be performed by an intermediate node.

Embodiments and examples provided herein describe actions that can be taken by a CMF or an SCMF. The actions that are described in embodiments and examples provided herein include actions being performed by the CMF or SCMF as a NF. Additionally or alternatively, the actions may be performed by the CMF or SCMF when the CMF, or the SCMF, is part of any other NF in 5GC, such as an AMF.

In embodiments and examples provided herein, a CMF is a functionality that may, store, process, authorize and grant a CT or a token to WTRUs that are permitted to communicate to the network regardless of its communication and registration state. The CMF may store the WTRU Identifications, granted CTs or tokens and associated identifiers, information, and rules. Also, the CMF may grant a CT or token to the WTRU based on the WTRU request, WTRU needs or subscription or WTRU policy information. Further, the CMF may validate a CT or token when data transmission is requested by the WTRU. The CMF may revoke a granted CT, extend/update the CT duration, or replace the existing CT in the WTRU.

In an example, the CMF may be an SCMF and the CT may be an SCT. For example, a SCMF is a functionality that may, store, process, authorize and grant an SCT to WTRUs that are permitted to communicate to the network regardless of its communication and registration state. The SCMF may store the WTRU Identifications, granted SCTs or tokens and associated identifiers, information, and rules. Also, the SCMF may grant an SCT to the WTRU based on the WTRU request, WTRU needs or subscription or WTRU policy information. Further, the SCMF may validate an SCT when data transmission is requested by the WTRU. The SCMF may revoke a granted SCT, extend/update the SCT duration or replace the existing SCT in the WTRU.

In an example, a WTRU may determine the availability of a wireless network. The WTRU may send a registration request to an AMF. The registration request may include an indication that communication may be requested. In an example, the communication may be SC. Further, the request may include information about request communication operations. In an example, the information may include one or more of an operation type, network function identities, application function identities, payload size, payload type, endpoint information, and the like.

Further, the WTRU may receive a registration accept message from the AMF. The registration accept message may include a CT granted by a CMF after the WTRU was authenticated and registered. In an example, the CT may be an SCT. Additionally or alternatively, the CMF may be an SCMF. The CT, SCT or the token may be based on the successful WTRU registration and can be only validated by the WTRU.

Also, the WTRU may become in a de-registered state and determines that it needs to send data. Additionally or alternatively, the WTRU may be capable of stateless communication, in an example. A stateless WTRU is not registered or has become de-registered with a communications network but may still communicate with a network and use network resources without registering with the network. Further, the WTRU may determine that it cannot obtain a stable connectivity with a network or may determine that it has a short connectivity opportunity with the network. The determination may be based on the WTRU connection becoming idle, or the WTRU becoming de-registered. Additionally or alternatively, the WTRU may detect connection instability, for example detecting an increase in bit error rate (BER), detecting a low receive power, losing radio coverage, or detecting a low battery which may limit transmission power or range. An example of stateless communication is a WTRU sending application data to a network when the WTRU is not registered to the network. Another example of stateless communication is the WTRU sending application data to network in the same message that requests that the WTRU be registered to the network. A payload is an example of application data. A stateless WTRU is a WTRU that is capable of stateless communication.

In addition, the WTRU may send a communication request message to the network. The communication request message may be a stateless communication request message, in an example. Further, in examples, the communication request message may be one or more of a NAS message, a message transparent or opaque to the Access Network, a message intended to be further processed by the Access Network, or any other message type. For example, the communication request message may be sent directly from the WTRU to a NF in the network using a Service Based like mechanism, such as, over quick UDP internet connections (QUIC).

Further, the communication request message may include one or more of a WTRU identifier, a CT, communications operation information, and communications payload data. In an example, the CT may be an SCT. Additionally or alternatively, the communications operation information may be SC operation information. Additionally or alternatively, the communications payload data may be SC payload data. Further, the payload content and size may be determined by the granted CT configuration. In an example, the CT configuration may be an SCT configuration. When the network receives the communication request message, the network first validates the CT for authorization. After the network checks the authorization for service requested and if the CT is still in a validity time frame, then the network shall provide the requested service. In an example, only after the network checks the authorization for service requested and the CT is still in the validity time frame, does the network provide the requested service.

Moreover, WTRU may receive a communication response message from the CMF. In an example, the communication response may be a stateless communication response. Further the communication response may include confirmation of data transmission, an indication that an CT time validity is extended, an indication that CT rules or privileges are changed, for example, privileges have been revoked, an indication that the CT has been revoked. In an example, the CT time validity is an SCT time validity. Additionally or alternatively, the CT rules may be SCT rules.

Additionally or alternatively, upon confirmation of data transmission, the WTRU may transmit payload data to the network, may receive payload data from the network, or may do both. In this way, after receiving a token or CT, the WTRU may communicate with the network without again registering with the network.

In an example, a CMF may receive a CT request from an AMF. Further, the CMF may be an SCMF. Additionally or alternatively, the CT request may be an SCT request, in an example. Additionally or alternatively, the CT requested in the CT request may be an SCT.

The CT request may include one or more of the WTRU identity, an indication that the WTRU is authenticated with the network, information about the selected network functions for the WTRU. In an example, the network function that authenticated the WTRU may be an AMF, an authentication server function (AUSF), or both. Further, the selection network function may include one or more of a unified data management (UDM) function, a policy control function (PCF), an AUSF, or the like.

Further, the CMF may use the provided information to access one or more of the UDM, UDR and PCF to obtain further information about the WTRU subscription, policy, and configuration for CT communication. In an example, the CT communication may be SCT communication. The CMF may obtain subscription information indicating if the WTRU is allowed to perform communication and may obtain policy and communication configuration information indicating the allowed communication such as the communication type, one or more network functions or one or more application functions involved in communication, information about the exchanged data. In an example, the communication may be SC. Additionally or alternatively, the communication configuration information may be stateless communication configuration information. Additionally or alternatively, the communication type may be a stateless communication type. Additionally or alternatively, the information about the exchanged data may include one or more of maximum data size, type, and the like, in examples. For example, the information about the exchanged data may include a number of tuples, such as 5 tuples.

Also, the CMF uses the provided and obtained information to generate a CT and digitally sign the CT so that the CT can be validated by the CT consumer that will provide the requested service. The token validation can also be performed by the CMF if the service provider cannot validate the CT.

In addition, the CMF sends a response to the AMF. The response may include the CT with one or more of the communication claims, scope, valid time frame, and other token parameters such as subject, audience, and those specified by one or more standards. In an example, the communication may be stateless communication. Additionally or alternatively, the token parameters may be specified by OAuth 2.0 [RFC 6749].

Further, the CMF may receive a communication request from the WTRU, via the access network. In an example, communication request may be a stateless communication request. Additionally or alternatively, the request may include one or more of the CT, communication operation information and a communication data payload. Additionally or alternatively, the communication operation information may be stateless communication operation information. Additionally or alternatively, the communication data payload may be stateless communication data payload.

Also, the CMF validates the provided CT. The CT includes information about the WTRU and selected network functions for WTRU at the time of CT granting. The CMF may validate with the AMF if the WTRU associated with the CT is in a state that allows usage of CT, for example, if the WTRU is in a de-registered state or an idle state. The CMF may validate with the AUSF if the WTRU was authenticated at the time the CT was issued.

If the CT is valid, the CMF may consider the requested operation information and provided data payload, according to the CT claims and scope. For example, if the CT allows reporting current and historical tracking information to the AMF, then the CMF validates if the requested operation is allowed and considers if the provided payload is within the limits and rules for the CT. The rules may include one or more of size, location, and the like, in examples.

If the CT, associated communication operation, data payload (or communication payload) are validated and according to the CT claims and scope, then the CMF performs the operation on behalf of the WTRU with the related network function. For example, the CMF may send a message to the AMF to report the current and historical tracking information. Additionally or alternatively, the communication payload may be a stateless communication payload.

Moreover, the CMF sends a communication response to the WTRU, via the AN. The communication response may be a stateless communication response, in an example.

The communication response may include information related to the requested operation. Additionally or alternatively, the communication response may include a new CT.

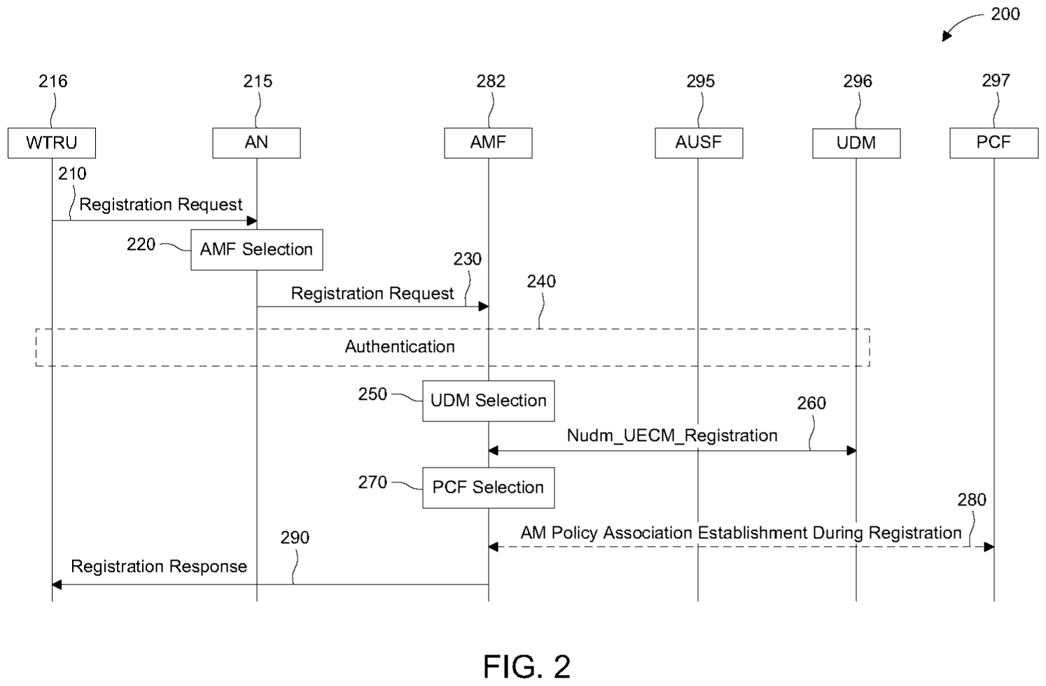

FIG. 2 is a signaling diagram illustrating an example of a registration procedure. As shown in signaling diagram 200, a WTRU 216 sends a registration request 210 to an access network (AN) 215. In an example, WTRU 216 may be the same as or similar to WTRU 102. Additionally or alternatively, the AN 215 may be an interface between a RAN, such as RAN 104, and a CN, such as CN 106. Additionally or alternatively, the AN 215 may be part of a base station, such as base station 114a. Additionally or alternatively, the AN 215 may be part of an access point. Additionally or alternatively, the AN 215 may be in communication with a base station or access point.

The registration request 210 may include one or more of AN parameters, registration type, subscriber concealed identifier (SUCI), 5G-globally unique temporary identifier (GUTI), permanent equipment identifier (PEI), last visited tracking area identity (TAI), security parameters, requested network slice selection assistance information (NSSAI), Mapping Of Requested NSSAI, WTRU Radio Capability Update, WTRU mobility management (MM) Core Network Capability, PDU Session status, List Of PDU Sessions To Be Activated, Follow on request, mobile initiated connection only (MICO) mode preference, Requested discontinuous reception (DRX) parameters, and a WTRU Policy Container. The WTRU Policy Container may include a list of policy selection identifiers (PSIs).

The AN 215 then selects 220 an AMF 282. In an example, AMF 282 may be the same as or similar to AMF 182a. The AN 215 sends a registration request 230 to the selection AMF 282. The registration request 230 has N2 parameters in addition to the parameter and information in registration request 210. The AMF 282 may be located in the CN.

The AMF 282 may perform WTRU authentication 240 regarding WTRU 216. The WTRU authentication 240 may involve one or more of the AN 215, an AUSF 295 and a UDM 296. The AUSF 295 and the UDM 296 may be located in the CN. The AUSF 295 may be responsible for verifying the identity of a subscriber, validating their subscription data, and determining the appropriate security context for the subscriber.

After performing WTRU authentication 240, if the AMF 282 has changed since the last registration procedure, the AMF 282 selects 250 the UDM 296.

The AMF 282 may register 260 with the UDM 296. For example, the AMF 282 and the UDM 296 may use Nudm_UECM_Registration.

Further, if the AMF 282 decides to initiate PCF communication, for example, if the AMF 282 has not yet obtained an Access and Mobility policy for the WTRU or if the Access and Mobility policy in the AMF 282 is no longer valid, the AMF 282 selects a PCF 297. The PCF 297 may be located in the CN.

The AMF 282 may perform an AM policy association establishment 280. For example, the AMF 282 and PCF 297 may use AM Policy Association Establishment during Registration.

Moreover, the AMF 282 may respond to the registration request with a registration response 290. The registration response 290 may have 5G-GUTI, Registration Area, Mobility restrictions, PDU Session status, Allowed NSSAI, Mapping Of Allowed NSSAI, Configured NSSAI for the Serving public land mobile network (PLMN), Mapping Of Configured NSSAI, Periodic Registration Update timer, local area data network (LADN) Information and accepted MICO mode, IMS Voice over packet switched (PS) session supported Indication, Emergency Service Support indicator and Accepted DRX parameters.

A device, for example, a wireless device, such as a WTRU, may have limited connectivity to the network due to limited coverage, cell congestion or poor radio conditions, for example, BER, or the like. This limited connectivity may lead the WTRU becoming de-registered or idle. In the current communication wireless system, the short, or limited communication opportunities may be wasted since the WTRU may need to go through the registration procedure again, before it can send user data to the network, or execute other procedures, for example, a PDU Session Establishment.

The WTRU may only need to communicate small amounts of data, for example, control plane information, location information, or the like. The WTRU may need to send critical user plane data, for example, measurements from a medical application in the WTRU to indicate critical medical condition has been detected.

In the current system, the network does not allow a WTRU to send User Plane or control plane information, such as Minimization of Drive Testing (MDT) data, other than a registration message, to the network when the WTRU is in de-registered state. The WTRU needs to go through an extensive and long procedure, for example, a registration procedure before it can establish a PDU session in order to communicate information to the network. It is important to point out that that a NAS security context is established in the registration procedure. Establishing a NAS security context in the registration procedure involves the WTRU sending and receiving multiple messages.

In light of the problems outlines, it is thus desirable to enable the WTRU to securely send time critical user plane or control plane data using short or limited connectivity opportunities, without requiring the WTRU to perform a complete further registration procedure, a complete update registration procedure, or both, and establish a new security context.

Embodiments and examples provided herein present a solution to enable the WTRU to communicate information to the network, for example, with user plane or control plane data, using communication, for example, to communicate user or control plane data, without the constraint of a specific state, while ensuring secure communications. In an example, the communication may be SC.

In certain example scenarios, while the WTRU is de-registered from the network due to limited coverage or poor channel or radio condition, the WTRU may need to send some important information to the network such as a WTRU location, or some urgent or time critical user plane information. The WTRU, under these network conditions, may need to take advantage of any available resources that may provide connectivity opportunities to send this information to the network.

The examples solutions provided herein propose to enable the WTRU to use communication using credentials, that are not constraint by a state. In an example, the communication may be SC. These credentials are provided to the WTRU during the registration procedure, or in response to a dedicated communication request, for example, a communications authorization request message, in the form of a CT. Note that the same credentials may be used to secure the interface between the WTRU and Access Network. For example, at the establishment of security mode during the registration procedure, the AMF may share the CT with the Access Network, to enable the Access Network to secure the WTRU-AN communication channel. In an example, the communication request may be a stateless communication request. Additionally or alternatively, the CT may be an SCT.

By using communications when the WTRU is in the possession of a valid CT, the WTRU may send messages while de-registered from the network. When the WTRU sends communications messages that include a CT, operation information and a data payload, the network may identify these messages and it may use a CMF to process such messages. In an example, the CMF may be an SCMF. The CMF may perform operations on behalf of the WTRU when provided with a valid CT.

In embodiments and examples provided herein a WTRU may have limited or short connectivity opportunities with the network due to limited coverage, cell congestion or high BER. The limited connectivity may lead the WTRU connectivity state to become idle or registration state to become de-registered.

The WTRU may take advantage of any connectivity opportunity to send tracking information to the network regardless of the WTRU connectivity state (idle, connected) or registration state (registered, de-registered) without going through a procedure which require time and high connectivity availability. Examples solutions proposed herein allow the WTRU to perform communication. In an example, the communication may be SC. The communication allows the WTRU to send data to the network regardless of the WTRU connectivity state (idle, connected) or registration state (registered, de-registered).

To perform communication, the WTRU is provided with a CT, via pre-configuration, via network registration or via other procedures. In an example, the CT may be an SCT.

The WTRU under limited connectivity condition may send information to the network by providing the CT, regardless of its connectivity or registration state. Example solutions provided herein may use a CMF, an SCMF or other network functions to assist the WTRU in performing network communication.

Embodiments and examples provided herein include CT provisioning. In an example, the CT may be an SCT.

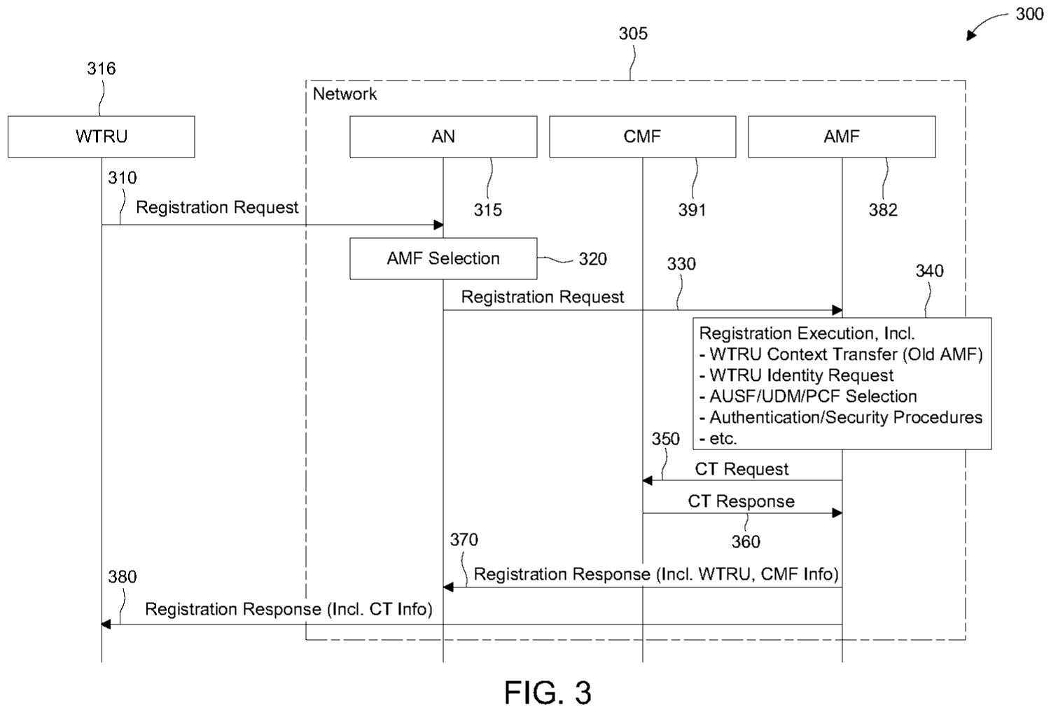

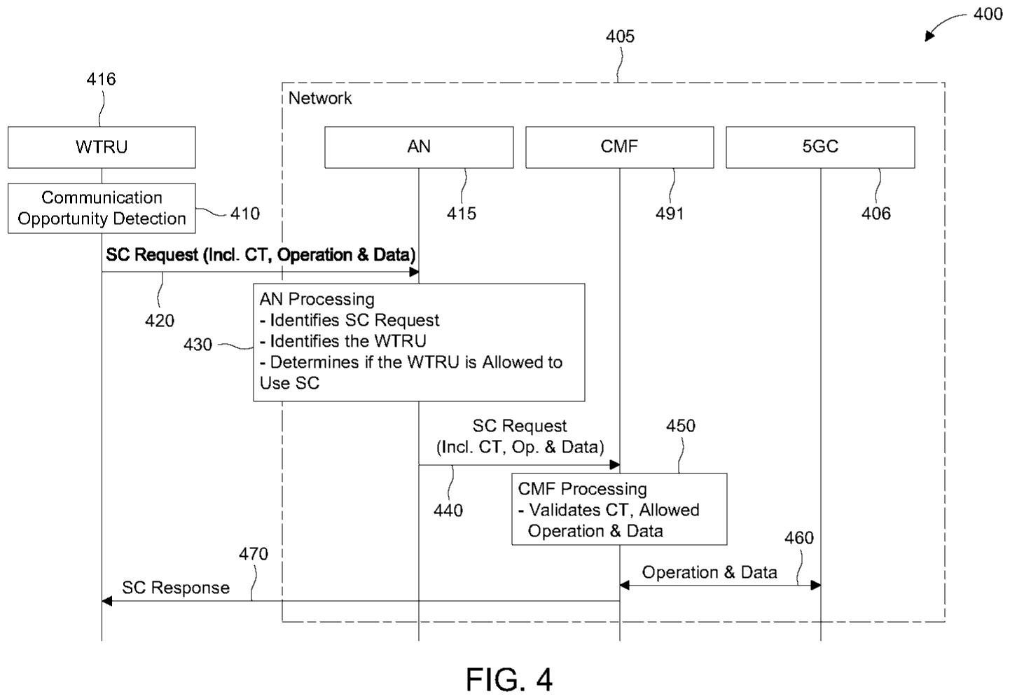

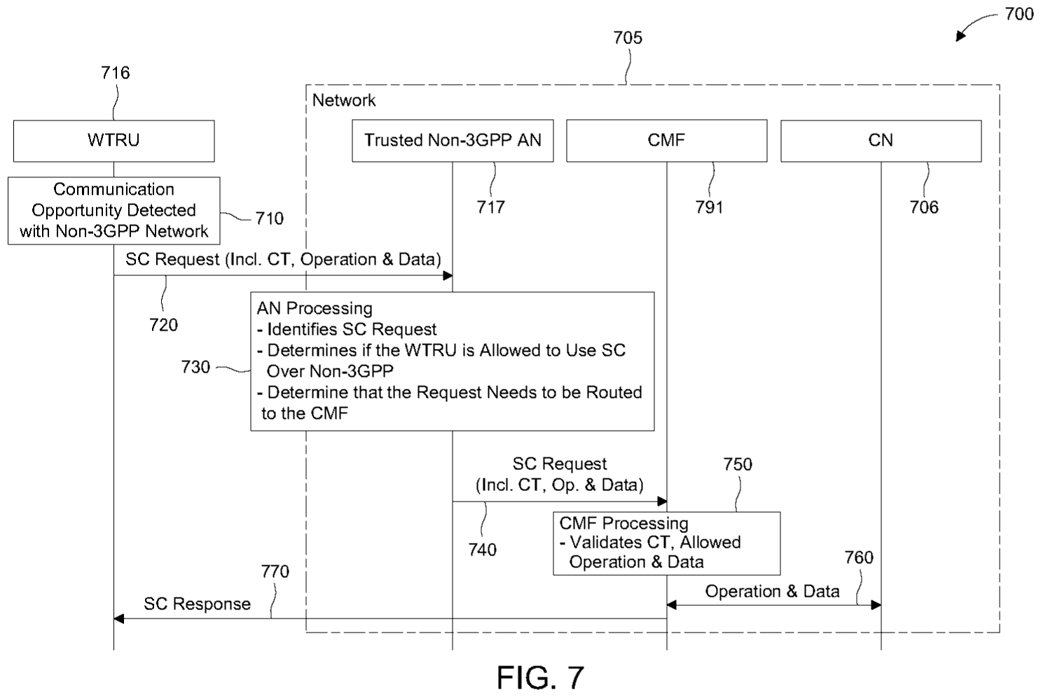

FIG. 3 is a signaling diagram illustrating an example of a procedure for requesting access to the communication capability and obtaining a CT. Signaling diagram 300 shows an example procedure for how the WTRU 316 can obtain a CT during a registration procedure. In an example, the CT may be an SCT. As shown in an example in FIG. 3, the WTRU 316 indicates that it wants to access the communications feature and the WTRU 316 receives a CT. Additionally or alternatively, the communication may be SC. The WTRU can then use the CT in a later procedure when using the communications feature. Example of procedures where the WTRU uses the CT to perform communication are shown further below, such in FIG. 4 and FIG. 7.

As shown in an example in FIG. 3, the WTRU 316 sends or transmits a NAS registration request 310 to a network 305. The registration request 310 may include, be in addition to or be in place of, parameters known to those having ordinary skill in the art. Further, the registration request 310 may include an indication that the WTRU needs to perform communication and information about the operations for which communication is requested. An AN 315, within network 305, may receive the registration request 310.

The information about the operation for communication may include one or more of the following. For example, the information may include the operation type which identifies the operation(s) for which stateless communication is requested. For example, the operation type may indicate, whether communication is requested to enable the WTRU to provide control plane data, for example, tracking information (for example, current location, historical location, current network sensed (for example, cells, WIFI, Bluetooth, etc.), measurements of radio conditions, etc.), or user plane data. For example, the operation type may indicate user plane data, to be transmitted, for example, using control plane transmission resources, towards a determined application function.

The information about the operation for communication may include network function profiles or application function identities, identify the network entities that may be involved in the communication operation. For example, the network function profile may indicate that the operation for reporting tracking information is performed by the AMF. For example, the application function may indicate an application function (AF) identifier that corresponds to a medical application for reporting medical information. A network function profile may include network function identity and network function type.

Also, the information about the operation for communication may include the egress payload information describes the characteristics of the payload sent from the WTRU to the network when performing the communication operation. For example, the egress payload information may indicate a size (for example, bytes), a frequency or interval, a payload type. For example, the egress payload information may indicate that the tracking information will be less than 1500 bytes, reported opportunistically (for example, at no pre-determined interval) and following a pre-determined payload format. The payload format may indicate that location is a combination of latitude in degrees, longitude in degrees, time, or may indicate that location is a combination of the sensed cell identifiers or Tracking Areas, and time.

Further, the information about the operation for communication may include the ingress payload information to describe the characteristics of the payload sent from the network to the WTRU as a result of performing the communication operation. For example, the ingress payload information may indicate whether an ingress payload is expected, a size or payload type.

Moreover, the information about the operation for communication may include a NF profile, endpoint information, or fully qualified domain name (FQDN) of the network or application function for servicing the operation for communication. For example, if the operation is with the AMF, the NF Profile may indicate that the operation should be performed with the currently selected AMF (for example, the selected AMF, after registration, which may be encrypted in the CT when it is issued). For example, if the operation is with an AF, the endpoint information may indicate the uniform resource locator (URL) of the AF to use for the corresponding operation.

For example, communication may be requested for transmitting current and historical tracking information or reachability information to the network. Additionally or alternatively, the communication may be requested for communicating user plane or control plane information to the network (for example, network functions) or to one or more AFs.

In addition, after receiving the registration request, the AN 315 selects 320 an AMF 382. The radio resource control (RRC) message that carries the registration request message 310 may include an indication that the WTRU 316 wants to use the communication feature. In an example, the communication feature may be an SC feature. Based on the indication in the RRC message, the AN 315 may select 320 an AMF 382 that supports the communication feature. The AN may be configured with information about which one or more AMFs support the communication feature.

Further, the AN 315 sends the NAS registration request 330 to the selected AMF 382. The registration request 330 may have all parameters that presented in the original registration request 310.

Moreover, after receiving the registration request from AN 315, the AMF 382 communicates with other 5GC network functions to perform the WTRU registration 340. This WTRU registration may be as known to those having ordinary skill in the art. The AMF 382 may contact the AUSF for authentication, the UDM for WTRU context update, and the PCF to obtain an access and mobility policy. Accordingly, registration execution may include one or more of WTRU context transfer (such as with an old AMF), WTRU identity request, AUSF/UDM/PCF selection, authentication/security procedures, or the like.

In addition, if the WTRU 316 is authenticated successfully and the WTRU registration request is accepted, and the WTRU has indicated communication in the registration request and/or the WTRU subscription or policy indicates that the WTRU 316 needs to perform communication operations, the AMF 382 may send a request 350 to a CMF 391 to obtain one or more CTs for the registering WTRU 316. In an example, the CMF 391 may be an SCMF. Additionally or alternatively, the request 350 may be a CT request. Additionally or alternatively, the request 350 may be an SCT request.

The AMF 382 may use the NF profile or AF identity provided by the WTRU 316 to locate the CMF, for example, using a network repository function (NRF). The request 350 to the CMF 391 may include the WTRU identity, an indication that the WTRU is successfully authenticated with the network (for example, AMF 382/AUSF), and an indication that the WTRU 316 is successfully registered with the network, and information about the operation for communication (for example, requested by the WTRU 316 and/or from the WTRU policy/subscription). Additionally or alternatively, the request 350 may include information as described in the example regarding registration request 310, including information about the operation for communication, network function profiles and application function identities.

Additionally or alternatively, the request 350 may include information from the registration procedure that reflect the WTRU registration state.

The CMF 391 may use the provided information to access the UDM, UDR and PCF to obtain further information about the WTRU subscription, policy, and configuration for CT communication. The CMF 391 may obtain subscription information indicating if the WTRU is allowed to perform communication and may obtain policy and communication configuration information indicating the allowed communication such as the communication type, the network function(s) or application functions involved in communication, information about the exchanged data (for example, maximum data size, type, 5 tuples, etc.). The CMF 391 may validate with the AUSF if the WTRU for which the CT is requested is successfully authenticated and registered.

If the CMF 391 has generated one or more CTs for the registering WTRU 316, the CMF 391 may send a response message 360 to the AMF 382. Additionally or alternatively, the response message 360 may be a CT response message. Additionally or alternatively, the response message 360 may be an SCT response message. The response message 360 may include one or more CTs, CT claims and scope, and a valid time for using each of the CTs.

In examples, the claims and scope in a CT may include one or more of: information about the operation that can be performed with the CT, network or application functions with which to perform the operation, payload information (for example, size, endpoint, frequency or periodicity, etc.), location where the CT can be used, time of the day when the CT can be used, detection rules indicating the detection triggers for using the CT, expiry Date/Time of the CT. It can be appreciated that the CT claims and scope may be provided along with the CT with a digital signature by the CMF. In an example, the CT claims may include information regarding the registering WTRU 316, such as the WTRU ID. Additionally or alternatively, the CT claims may include information regarding the CMF 391. Further, the scope may include one or more claims, or a group of claims.

The AMF 382 may send a registration response 370 to the AN 315. In an example, the registration response 360 may be sent over an N2 interface. The registration response message 360 may include the registration outcome, one or more granted CTs and the associated CT claims and scope. The AN 315 may record this information. In an example, the registration response 360 may include WTRU 316 information, CMF 391 information, or both.

Further, the AMF 382 may send a registration response 380 to the WTRU 316. In an example, the AMF 382 may send the registration response 380 to the WTRU 316 by way of the AN 315. Additionally or alternatively, the AMF 382 may send the registration response 380 directly to the WTRU 316. The registration response message 380 may include the registration outcome, registration parameters, the granted CT, and further CT information. In an example, the registration response may be a registration accept message.

Upon receiving CT information, the WTRU 316 may store the CT information for future use. The WTRU 316 may then detect a condition that causes the WTRU 316 to determine that data needs to be sent, and then may use the CT claim and scope to determine a suitable time to send data and a suitable CT to use when sending data. FIG. 4 and FIG. 7 further below show examples of how the WTRU may use the CT to send data.

In additional or alternative examples, the WTRU, instead of sending a registration request, may send a communication specific message, for example, communication-authorization request message, to the AN to request one or more CTs. In an example, the communication specific message may be a stateless communication specific message. Additionally or alternatively, the communication-authorization request message may be an SC-authorization request message. Additionally or alternatively, the one or more CTs may be one or more SCTs.

The AN may forward this message to an AMF, and then the procedure will be the same as described above. Additionally or alternatively, AN may directly forward the message to the CMF. In an example, the CMF may be an SCMF. The message may or may not be a NAS message, but the parameters contained in the message can be the same as described above in the example regarding the registration request 310. A CMF upon reception of the communication-authorization request message may generate a communication-authorization response message that may include one or more CTs and possibly other parameters as stated in the example regarding the registration response 360. In an example, the communication-authorization request message may be a stateless communication-authorization request message.

The CMF may then send the communication-authorization response message to the WTRU, directly or via the AMF. The CMF may coordinate with the network functions, for example, AMF/AUSF, UDM, or the like, or with the application function via an NEF for the authorization of the WTRU.

FIG. 4 is a signaling diagram illustrating an example of a procedure for WTRU communication using a CT. In an example, the communication may be SC. Additionally or alternatively, the CT may be an SCT. As shown in an example in signaling diagram 400, a WTRU 416 may be de-registered and may detect that it needs to send data. Accordingly, the WTRU may perform communication opportunity detection 410. Furthermore, the WTRU 416 may detect that it has only limited network availability which may not be enough to register to the network 405. For example, the WTRU 416 may be de-registered from the network 405 and have failed to re-register to the network 405 for certain number of times due to limited connectivity.

The limited connectivity may be detected by the WTRU 416 based on the amount of time the WTRU 416 detected continuous connectivity. The limited connectivity detection may be based on the WTRU 416 connection becoming idle, or the WTRU 416 becoming de-registered. Additionally or alternatively, the WTRU 416 may detect connection instability, for example detecting an increase in BER, detecting a low receive power, losing radio coverage, or detecting a low battery which may limit transmission power or range. Since the WTRU 416 has data to send and it has detected that the WTRU 416 only limited network availability, the WTRU 416 may use the claims and scopes of the CTs that were received in the examples in procedures shown in FIG. 3 to determine a suitable time to attempt to send data and a suitable location to send data to.

Further, the WTRU 416 may send a communication request 420 to the network 405. In an example, the communication request 420 may be sent to an AN 415. Additionally or alternatively, the communication request 420 may be an SC request. The communication request message 420 may include a WTRU identifier, the CT that was determined in step 410, communication operation information, and payload data associated with the communication operation. In an example, the communication operation may be a stateless communication operation. The information may include one or more of: the current WTRU 416 location; the trigger to send data to the network using communication such high BER; the expiry date/time of the CT; payload characteristics such as payload type and size; or NFs in in CN who should be contacted regarding this communication request.

Also, the AN 415 receives the communication request 420 from the WTRU 416, and may identify that the message is for communication. Accordingly, the AN 415 may perform related AN processing 430. The AN 415 may detect that the communication request 420 is a message for communication based on an indication in the RRC message. The AN 415 may check if a CT is present in the request and check if the WTRU 416 is authorized to send information to the network using communication. Accordingly, the AN 415 may identify the communication request, may identify the WTRU 416, or both. Further, the AN 415 may determine if the WTRU 415 is allowed to use communication, such as SC. The authorization may be determined based on the AMF indicating to the AN 415 that the WTRU 416 is authorized for communication during the registration. It can be appreciated that the AN 415 may also obtain that information from the AMF by notifying or requesting the AMF for communication authorization. In an example, the communication authorization may be an SC authorization.

If the WTRU 416 is permitted to perform communication, the WTRU communication request 420 which is received will be sent as a communication request 440 to a CMF 491. In an example, the CMF 491 may be an SCMF. Additionally or alternatively, the communication request 440 may include one or more of the CT, communication operation information and a data payload. In an example, the data payload may be a communications data payload. Additionally or alternatively, the data payload may be an SC data payload.

In addition, the CMF 491 validates 450 the provided CT 450. The CT includes information about the WTRU 416 and selected network functions for WTRU 416 at a time of CT granting (for example, registration). The CMF 491 may validate with the AMF if the WTRU 416 associated with the CT is in a state that allows usage of CT, for example if the WTRU is in a de-registered state or idle state. Accordingly, the CMF 491 performs processing which includes allowed operation and the data payload.

If the CT is valid, the CMF 491 may consider the requested operation and provided data payload according to the CT claims and scope. For example, if the CT allows reporting current and historical tracking information to the AMF, then the CMF 491 validates if the requested operation is allowed and considers if the provided payload is within the limits and rules (for example, size, location, time of day. etc.) for the CT.

If the CT, associated communication operation and communication data payload are validated, and match the CT claims and scope, the CMF 491 may perform the operation on behalf of the WTRU 416 with the related network function. For example, the CMF 416 may send a message 460 to the 5GC 406 with operation information and the data payload. In an example, the CMF 416 may send the message 460 to the AMF to report the current and historical tracking information. For example, the CMF 416 may send a message to the UDR to store the current and historical tracking information. For example, the CMF may send a message to the AF which may have critical user information.

Moreover, the CMF 491 responds 470 to the request message from the WTRU. The response 470 may include a confirmation that the operation has been performed. In an example, the response 470 may be a communication response. Additionally or alternatively, the response 470 may be an SC response. If the operation information indicates that the operation may include an ingress payload and if such data was provided by the network or application function, the response includes the ingress data. The response may also include information about the current CT (for example, valid, revoked or a new CT (for example, updated, renewed)).

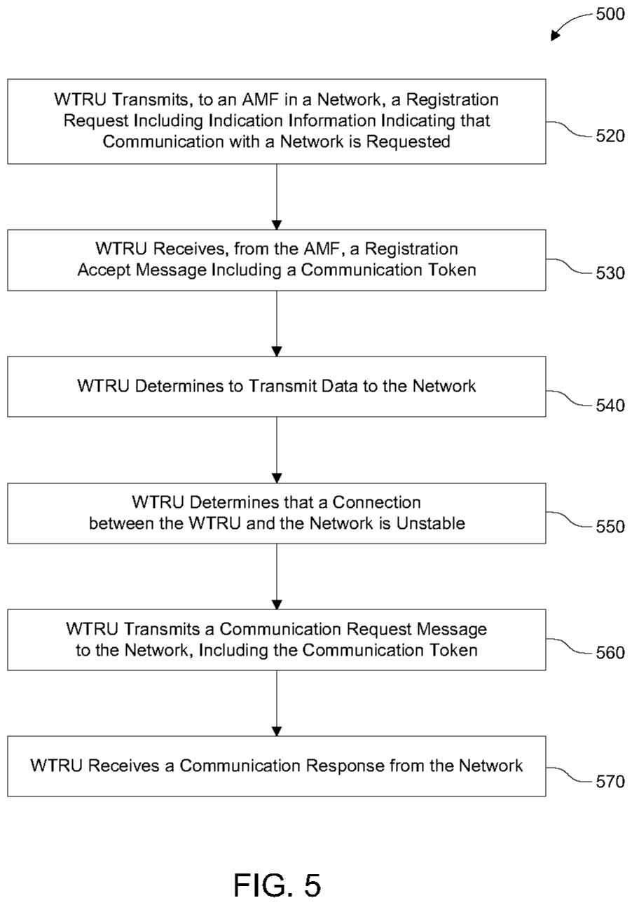

FIG. 5 a flowchart diagram illustrating an example of requesting access to a communication capability and obtaining a CT. As shown in an example in flowchart diagram 500, a WTRU transmits, to a network node in a network, a registration request including information indicating that a communication with the network is requested 520. In an example, the communication may be SC. Additionally or alternatively, the network node may be an AMF. Additionally or alternatively, the registration request may include information about requested communication operations. Additionally or alternatively, the information may be indication information. Additionally or alternatively, the information about requested communication operations may include one or more of an operation type, network function identities, application function identities, payload size, payload type, endpoint information, and the like.

The WTRU receives, from the network node, a registration accept message including a CT 530. In an example, the CT may be granted by a CMF. Additionally or alternatively, the CMF may be an SCMF. Additionally or alternatively, the CT may be an SCT.

Additionally or alternatively, the CT may be granted by the CMF after the WTRU was authenticated and registered. For example, the CMF may authenticate and register the WTRU. Additionally or alternatively, the CT may be based on the successful WTRU registration.

Further, the WTRU determines to transmit data to the network 540. In an example, the WTRU may make this determination after becoming in a de-registered state. Additionally or alternatively, the WTRU may be stateless, in an example.

Also, the WTRU determines that a connection between the WTRU and the network is unstable 550. The determination may be based on the WTRU connection becoming idle, or the WTRU becoming de-registered. Additionally or alternatively, the WTRU may detect connection instability, for example detecting an increase in BER, detecting a low receive power, losing radio coverage, or detecting a low battery which may limit transmission power or range.

Also, the WTRU transmits a communication request message to the network, including the CT 560. Additionally or alternatively, the communication request message may be one or more of a NAS message, a message transparent or opaque to the Access Network, a message intended to be further processed by the Access Network, or any other message type. Additionally or alternatively, the communication request message may be sent directly from the WTRU to a NF in the network using a Service Based like mechanism, such as, over QUIC.

Moreover, the WTRU receives a communication response from the network 570. Additionally or alternatively, the communication response includes a confirmation of data transmission. Additionally or alternatively, the communication response is received from the CMF. Additionally or alternatively, the communication response includes indication information indicating that one or more CT rules have changed. Additionally or alternatively, the communication response is an SC response.

In examples provided herein, a CT may be updated. The network may update, or revoke granted CTs. For example, the CT may contain information related to the WTRU registration state, and the information may change due to a mobility event, location change, CT privileges changes or security changes. In an example, the granted CTs may be granted SCTs.

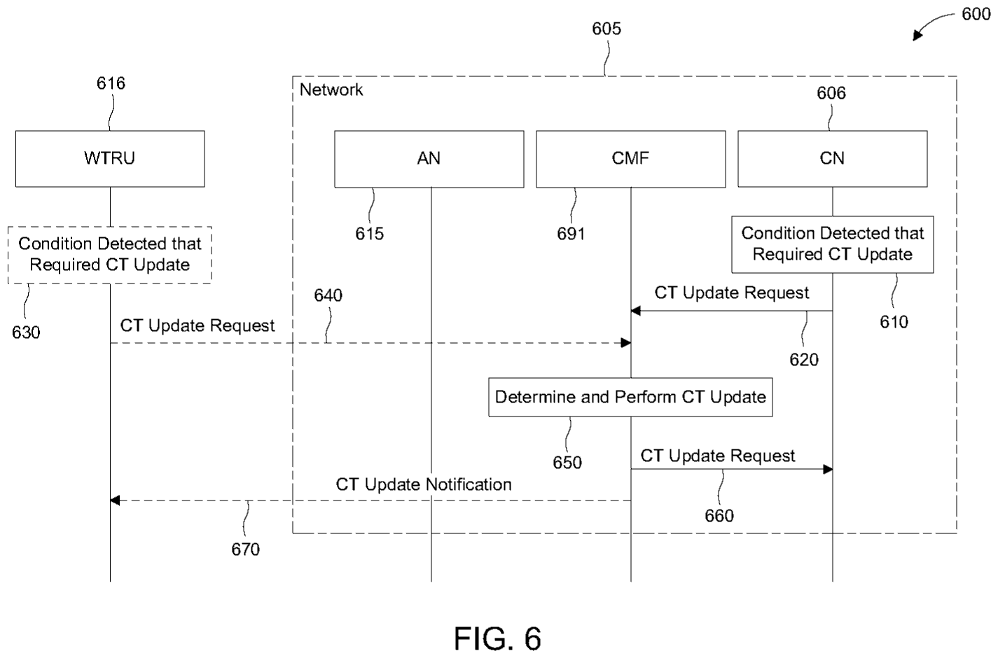

FIG. 6 is a signaling diagram illustrating an example of a procedure for updating a CT. In an example shown in signaling diagram 600, an event may be triggered in the CN 606 that affects the registered WTRU 616 state. Accordingly, a condition may be detected that requires a CT update 610. In an example, the CT may be an SCT.

For example, the WTRU 616 may go through a mobility event which causes re-selection of network functions such as the AMF, SMF, UDM/UDR, AUSF selected to serve the registered WTRU 616. Additionally or alternatively, the scope of a CT may be modified via a policy, a configuration, a user action.

Additionally or alternatively, the WTRU 616 may start roaming in a new network. Additionally or alternatively, a registration update may be triggered by the WTRU 616 and in turn, trigger the AMF to perform re-selection of the network function assigned to the registered WTRU 616.

Additionally or alternatively, the CMF may receive security warning notification from the AMF or any other NFs regarding abnormal behavior by the WTRU 616 or abnormal usage of the CT by the WTRU 616. This may include high rate of communication requests toward the network, using the CT, which exceed certain threshold and may be considered threatening to the network security. Additionally or alternatively, the communication requests may be SC requests.

Additionally or alternatively, CN 506 may be triggered to send a CT update request 620 to a CMF 691. In an example, the CMF 691 may be an SCMF. Additionally or alternatively, the CT update request 620 may be an SCT update request.

Additionally or alternatively, the WTRU 616 may detect a condition that requires a CT update 630. Accordingly, the WTRU may be triggered to send an CT update request 640 for the network 605. Additionally or alternatively, the CT update request 640 may be an SCT update request. The following include examples of detecting a condition prompting a CT update.

In an example, CT in the WTRU may have expired. Additionally or alternatively, a request may be from the WTRU to rescope the CT, such as a request from the AF in the WTRU to change the type of data that can be sent using the CT.

Additionally or alternatively, the detection of state modifying event may require CN to trigger the CMF to update CTs granted to a WTRU such that the CT information is updated accordingly to reflect the state changes. Additionally or alternatively, the AMF may re-select network functions and trigger the CMF to update the CT. For example, a WTRU location change may lead to change in the WTRU serving network function which require a CT update.

The CMF 691 may receive a CT update request. For example, the AMF may have detected that a CT update is needed and send the message to the CMF. The request may include any information mentioned in the example regarding request 350 in FIG. 3. For example, the request may include the WTRU identity, an indication that the WTRU is successfully authenticated with the network (for example, AMF/AUSF), an indication that the WTRU is successfully registered with the network, and information about the operation for communication (for example, requested by the WTRU and/or from the WTRU policy/subscription), information from the registration procedure that reflects the WTRU registration state, such as the selected network functions for the WTRU (for example, UDM, PCF, AUSF, etc.). In an example, the communication may be SC. Additionally or alternatively, the CT update message may be a request to revoke the CT from a certain WTRU. Alternatively or additionally, the request update may be sent from the WTRU, if the WTRU is triggered in send a CT update, as shown in step 640.

Further, the CMF 691 may determine and perform a CT update 650. For example, the CMF 691 may identify the WTRU for which the update request has been sent and may identify the one or more CTs that are impacted by the request. Based on the information received in the request, the CMF may determine that one or more CTs need to be re-issued and may generate one or more CTs as described in the example regarding response message 360 in FIG. 3.

Additionally or alternatively, the CMF 691 may determine that CT needs to be revoked based on the information included in the request.

The CMF 691 sends a CT update response 660 to the requestor. The update response 660 may include a list of newly issued CT, may include a list of revoked CT, may include an indication that the CMF notifies the WTRU about the updated CTs, or may include an indication that the requestor notifies the WTRU about the updated CT or may indicate that no WTRU update is required.

For example, if the CMF 691 has indicated in the CT update response 660 that the requestor notifies the WTRU, and if the requestor of CT update request 640 is the AMF, then the AMF may send a registration update to the WTRU including the updated or revoked CT.

For example, if the CMF 691 has indicated in the CT update response 660 that the CMF 691 notifies the WTRU, the CMF may send a CT update notification 670 to the WTRU. The update notification 670 may include the updated CT or may contain information about revoked CTs. Additionally or alternatively, the CT update notification 670 may be an SCT update notification. Additionally or alternatively, the CT update notification 670 may sent to an AN 615, and the AN 615 may then forward the CT update notification 670 to the WTRU 616.

FIG. 7 is a signaling diagram illustrating an example of a procedure for CT usage with non-3GPP networks. Signaling diagram 700 illustrates an example procedure for how the WTRU performs communication through a non-3GPP network. In an example, the communication may be SC. For example, when a WTRU has lost mobile network connectivity and has become de-registered, the WTRU may use non-3GPP access to report information using communication.

A WTRU 716 may detect a condition 710 related to the use of a CT. In an example, the CT may be an SCT. Additionally or alternatively, the detection may be as described in the example regarding step 410 in FIG. 4. Accordingly, the WTRU 716 may detect a communication opportunity with a non-3GPP network 710. Additionally or alternatively, the WTRU 716 may detect trusted non-3GPP network 705 availability. The WTRU 716 may use the available non-3GPP network 705 due to lack or limited connectivity to the 3GPP Access network. The capability to perform communication through a non-3GPP network 705 may be granted to the WTRU 716 when communication capability and the corresponding one or more CTs are granted. For example, the service set identifier (SSID) of the non-3GPP network 705 may be part of the CT scope and claims.

The WTRU 716 send a communication request 720 to a trusted non-3GPP AN 717. The trusted non-3GPP AN 717 receives the communication request 720. In an example, the communication request 720 may be an SC request. Additionally or alternatively, the communication request 720 may include information regarding a CT, communication information and payload data.

Further, the trusted non-3GPP AN 717 may check 730 that the communication request 720 is a message for communication, and forward the message to the CMF 791. In an example, the CMF 791 may be an SCMF. The AN 717 may perform AN processing 730, and may check with CN 706 if WTRU 716 is permitted to perform communication over a non-3GPP network. Additionally or alternatively, the AN 717 may identify an SC request. Additionally or alternatively, the AN 717 may identify the WTRU 716. In this way, the AN 717 may determine if the WTRU 716 is allowed to use non-3GPP communication, such as non-3GPP SC.

If the WTRU is permitted to perform communication over a non-3GPP network, such as SC, the WTRU communication request which is received in step 720, will be sent 740 to the CMF 791. The communication request 740 may be an SC request. Additionally or alternatively, the communication request 740 may include information regarding a CT, communication information and payload data.

The CMF 791 may perform CMF processing 750, and may validate the CT. Further, the CMF 791 may determine allowed communication operation and communication payload data. In an example, the allowed communication operation may be allowed SC operation. Additionally or alternatively, the communication payload data may be SC payload data. Additionally or alternatively, the CMF processing 750 may be the same as or similar too CMF processing performed in step 450 in FIG. 4.

Further, if the CT, associated communication operation, communication data payload are validated and match the CT claims and scope, the CMF 791 may perform the allowed operation 760 on behalf of the WTRU 716 with the related network function. For example, the CMF 791 may send a message to the AMF or UDR to report the current and historical tracking information.

Moreover, the CMF 791 may respond to the request message from the WTRU. The communication response 770 may include a confirmation that the operation has been performed. Additionally or alternatively, the communication response 770 may be an SC response. If the operation information indicates that the operation may include an ingress payload and if such data was provided by the network or application function, the response includes the ingress data. The response may also include information about the current CT (for example, valid, revoked or a new CT (for example, updated, renewed, or the like). The WTRU 716 may then perform communication, such as SC, with the non-3GPP network 705.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed in a wireless transmit/receive unit (WTRU), the method comprising:
transmitting, to a network node in a network, a registration request including information indicating that a communication with the network is requested;
receiving, from the network node, a registration accept message including a communication token (CT);
determining to transmit data to the network;
determining that a connection between the WTRU and the network is unstable;
transmitting, to the network, a communication request message, including the CT; and
receiving, from the network, a communication response.

2. The method of claim 1, wherein the communication is stateless communication (SC) and the network node is an AMF.

3. The method of claim 1, wherein the registration request further includes information about the requested communication, including one or more of: an operation type, one or more network function identities, one or more application function identities, payload size, payload type, or endpoint information.

4. The method of claim 1, wherein the CT is granted by a communication management function (CMF).

5. The method of claim 4, wherein the CMF is a stateless CMF (SCMF) and the CT is a stateless CT (SCT).

6. The method of claim 1, wherein the communication request message is a non-access stratum (NAS) message.

7. The method of claim 1, wherein the communication response includes a confirmation of data transmission.

8. The method of claim 4, wherein the communication response is received from the CMF.

9. The method of claim 1, wherein the communication response includes information indicating that one or more CT rules have changed.

10. The method of claim 1, wherein the communication response is an SC response.

11. A wireless transmit/receive unit (WTRU) comprising:
a transceiver; and
a processor operatively coupled to the transceiver; wherein:
the transceiver is configured to transmit, to a network node in a network, a registration request including information indicating that a communication with a network is requested;
the transceiver is configured to receive, from the network node, a registration accept message including a communication token (CT);
the processor is configured to determine to transmit data to the network;
the processor is configured to determine that a connection between the WTRU and the network is unstable;
the transceiver is configured to transmit, to the network, a communication request message, including the CT; and
the transceiver is configured to receive, from the network, a communication response.

12. The WTRU of claim 11, wherein the communication is stateless communication (SC) and the network node is an AMF.

13. The WTRU of claim 11, wherein the registration request further includes information about the requested communication, including one or more of: an operation type, one or more network function identities, one or more application function identities, payload size, payload type, or endpoint information.

14. The WTRU of claim 11, wherein the CT is granted by a communication management function (CMF).

15. The WTRU of claim 14, wherein the CMF is a stateless CMF (SCMF) and the CT is a stateless CT (SCT).

16. The WTRU of claim 11, wherein the communication request message is a non-access stratum (NAS) message.

17. The WTRU of claim 11, wherein the communication response includes a confirmation of data transmission.

18. The WTRU of claim 14, wherein the communication response is received from the CMF.

19. The WTRU of claim 11, wherein the communication response includes indication information indicating that one or more CT rules have changed.

20. The WTRU of claim 11, wherein the communication response is an SC response.
